(19) United States
(12) Patent Application Publication
(10) Pub. No.: US 2024/0131694 A1
(43) Pub. Date: Apr. 25, 2024

(54) UNIVERSAL TRANSLATOR CONTROL SYSTEM FOR REMOTE CONTROL OF ROBOT WITH JOYSTICK USING TRANSLATED CONTROL SIGNAL

(71) Applicant: National Chung Cheng University, Chiayi (TW)

(72) Inventor: Rong-Guey Chang, Chiayi (TW)

(21) Appl. No.: 18/071,956

(22) Filed: Nov. 30, 2022

(30) Foreign Application Priority Data
Oct. 19, 2022 (TW) 111139889

(51) Int. Cl. B25J 9/16; B25J 13/06; B25J 19/02

(52) U.S. Cl. CPC B25J 9/1607; B25J 9/161; B25J 13/065; B25J 19/02

(57) ABSTRACT

A universal translator control system for remote control of a robot with a joystick. The system includes a calculation unit for storing translation logic, a control access interface unit electrically connected to the calculation unit, and a joystick which is operated to generate signals that have at least an X-coordinate value, X-direction rotation value, Y-coordinate value, Y-direction rotation value, Z-coordinate value, and Z-direction rotation value. Specifically, a robotic access interface unit is electrically connected to the calculation unit and the robot, whereby the translation logic in the calculation unit is used to translate the signals generated by the joystick as a translated X coordinate value, translated X-direction rotation value, translated Y coordinate value, translated Y-direction rotation value, translated Z coordinate value, and translated Z-direction rotation value, which are transmitted to the robot.

### FIELD OF THE DISCLOSURE

The present disclosure relates in general to a control signal interpretation technology between a robot and joystick, and more particularly, to a universal translator control system, which can translate different signals from different types of joysticks into a translated signal that can be transmitted to, and received/read by the robot for remote control of the robot by the joystick.

### BACKGROUND OF THE DISCLOSURE

There are various types of conventional robot applications, and robots are also used in the manufacturing industry to automate work. After the outbreak of COVID-19, the world fell into an unprecedented pandemic, and the use of robots that can replace actual human labor has been given more attention so that unnecessary contact between humans can be reduced.

In recent years, Industry 4.0 has been a hot topic, and industrial robots are booming. The key architecture of Industry 4.0 is a Virtual Network-Physical System (CPS), also known as Virtual Integrated System, which is an integrated control system that combines physical devices with computer computing field. The IoT (Internet of Things) and IIoT (Industrial Internet of Things), which relate to the concept of networking, apply cloud computing to collect information from various sensors, use emerging technologies such as artificial intelligence and cognitive computing to make predictions or analyze the current situation autonomously to achieve dynamic control and modular production methods of mutual communication between machines, and achieve the goals of smart manufacturing, smart medical care and smart agriculture.

Due to the highly infectious nature of COVID-19, the chance of human contact is reduced to minimize the chance of infection. As a result, the contact between medical personnel and patients is also reduced in favor of teleconsultation. However, in some occasions where human contact equipment (e.g., ultrasound scanner) is required, it is difficult to control the human body by remote control of the robot arm for ultrasound scanning with the current telemedicine technology. Therefore, overcoming such problem will enable physicians to perform ultrasound scans or other operations on patients at a distance, thereby greatly improving the quality and accuracy of telemedicine.

In addition, a majority of conventional remote control technologies use proprietary equipment, which is not only expensive, but also requires proprietary specification directed to specific operating lever or button. Therefore, professional training and learning are needed before use. Indeed, for medical personnel, there is a learning threshold for the proprietary specification that would hinder the promotion in using the joystick. However, if one can simply use ordinary household joysticks as electronic devices that one is already familiar with, such as the joysticks that one used for television game consoles or smart phones, which can include attitude sensing capabilities, then the learning threshold can be greatly reduced in the early stage of use to achieve rapid familiarity and effective operation.

To summarize, the problems with the conventional technology are that due to proprietary interfaces, additional learning and training are required, and that there is no remote control system for which the robot or robot arm is controlled remotely by different joysticks. In fact, currently there is no remote control system for robots that can effectively translate signals from, or be controlled by, different joysticks.

### SUMMARY OF THE DISCLOSURE

It is therefore an object of the present disclosure to provide a universal translator control system for remote control of a robot with a joystick, which can translate the signals from multiple joysticks into signals that can be received and read by the robot, and transmit the interpreted signals to the robot for control thereof.

Another object of the present disclosure is to provide a universal translator control system for remote control of robots with joysticks, which can be universally adopted by various joysticks, thereby resolving the issue of high learning threshold stemming from proprietary interfaces.

In order to achieve the above-mentioned object, the present disclosure proposes a universal translator control system that can remotely control a robot with a joystick. The universal translator control system includes a control access interface unit electrically connected to the joystick in a wired or wireless manner, wherein the control access interface unit is used to interface an operational signal transmitted from the joystick, and wherein the operational signal generated by the joystick include at least an X coordinate value, X-direction rotation value, Y coordinate value, Y-direction rotation value, Z coordinate value, and Z-direction rotation value; a calculation unit electrically connected to the control access interface unit in a wired or wireless manner for receiving the operational signal interfaced by the control access interface unit, and for storing translation logic and having an operation capability to execute the translation logic to perform translation, wherein the translation logic includes: calculating the X coordinate value by using an X matrix determinant to obtain a translated X coordinate value, calculating the X-direction rotation value by using an X-direction rotation matrix determinant to obtain a translated X-direction rotation value, calculating the Y coordinate value by using a Y matrix determinant to obtain a translated Y coordinate value, calculating the Y-direction rotation value by using a Y-direction rotation matrix determinant to obtain a translated Y-direction rotation value, calculating the Z coordinate value by using a Z matrix determinant to obtain a translated Z coordinate value, and calculating the Z-direction rotation value by using a Z-direction rotation matrix determinant to obtain a translated Z-direction rotation value; and a robot access interface unit electrically connected to the robot and the calculation unit in a wired or wireless manner, and transmits the translated X coordinate value, the translated X-direction rotation value, the translated Y coordinate value, the translated Y-direction rotation value, the translated Z coordinate value, and the translated Z-direction rotation value to the robot.

In this way, the present disclosure can effectively translate signals of a variety of joysticks during operation into translated signals that can be received and read by the robot, which can be provided to the robot for control thereof. In addition, since the present disclosure can be applied to different types of joysticks, a user can to choose a type of joystick that the user is familiar with, which overcomes the problem in the conventional technology involving a high learning threshold for each proprietary interface.

### BRIEF DESCRIPTION OF THE DRAWINGS

In order to illustrate the technical features of the present disclosure in detail, an exemplary embodiment is illustrated with drawings, wherein:

FIG. 1 is a block diagram of the universally translated robot system according to the exemplary embodiment of the present disclosure;

FIG. 2 is a flow chart showing a signal communication of the universally translated robot system according to the exemplary embodiment of the present disclosure;

FIG. 3 is another flow chart showing another signal communication of the universally translated robot system according to the exemplary embodiment of the present disclosure; and

FIG. 4 is a schematic diagram of the universally translated robot system according to the exemplary embodiment of the present disclosure.

### DETAILED DESCRIPTION OF THE EXEMPLARY EMBODIMENTS

In order to illustrate the technical features of the present disclosure in detail, the following exemplary embodiments are cited and illustrated with accompanying drawings, among others.

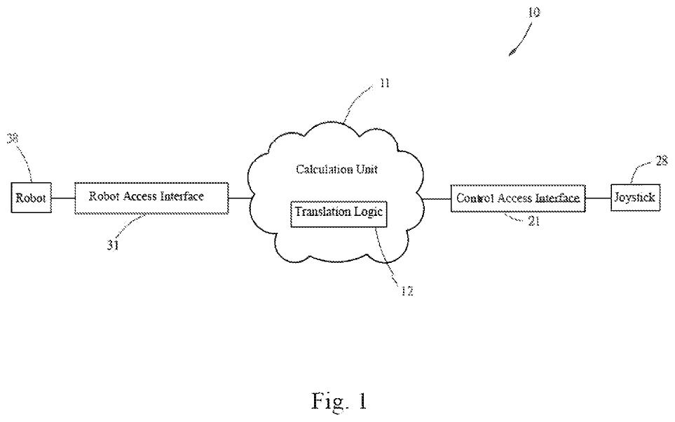

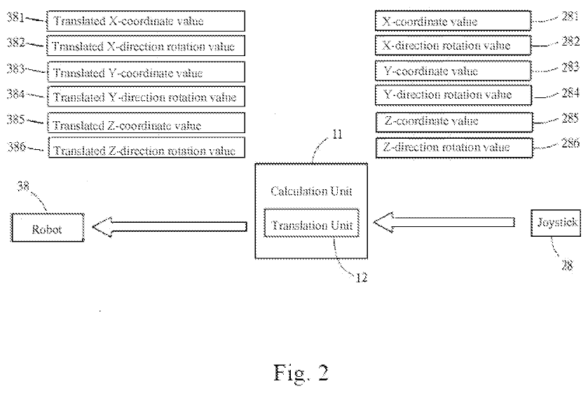

As shown in FIGS. 1 and 2, a first exemplary embodiment in the present disclosure includes a general purpose translate control system 10 for remote control of a robot by a joystick, consisting mainly of a calculation unit 11, a control access interface unit 21, and a robot access interface unit 31. The calculation unit 11 stores translation logic 12, the calculation unit 11 has computing power and executes the translation logic 12. The calculation unit 11 can be a device with computing power, such as a computer, stand-along server, or cloud server.

The control access interface unit 21 is electrically connected to the calculation unit 11 and a joystick 28 in a wired or wireless manner. The signals generated by the manipulation of the joystick 28 include an X coordinate value 281, an X-direction rotation value 282, a Y coordinate value 283, a Y-direction rotation value 284, a Z-coordinate value 285, and a Z-direction rotation value 286 for a total of six signals, which are transmitted between the joystick 28 and the calculation unit 11 via the control access interface unit 21. The joystick 28 can be a wireless joystick for home TV game consoles, such as the joystick of Nintendo's Wii, or the joystick of Sony's PS3 or PS4. The joystick 28 can also be a wireless joystick from a home TV game console, such as Nintendo's Wii joystick, or Sony's PS3 or PS4 joystick, all of which can generate the six signals described above, or a smartphone, which is a familiar electronic device with posture sensing capabilities that can also provide the six signals.

The robot access interface unit 31 is electrically connected to the calculation unit 11 and a robot 38 in a wired or wireless manner. The robot access interface unit 31 is used as a signal transmission interface between the calculation unit 11 and robot 38.

The translational logic 12 is discussed below.

The X coordinate value 281 is calculated by using an X matrix determinant to obtain a translated X coordinate value 381, which in the preferred embodiment is exemplary set as:

$$T X = [ \begin{matrix}1 & 0 & 0 & a \\ 0 & 1 & 0 & 0 \\ 0 & 0 & 1 & 0 \\ 0 & 0 & 0 & 1\end{matrix} ]$$

where a is the X coordinate value 281, and TX is the translated X coordinate value 381.

The X-direction rotation value 282 is calculated with an X-direction rotation matrix determinant to obtain a translated X rotation value 382. The X-direction rotation matrix determinant is exemplary set as:

$$R X = [ \begin{matrix}1 & 0 & 0 & 0 \\ 0 & cos ( α ) & - sin ( α ) & 0 \\ 0 & sin ( α ) & cos ( α ) & 0 \\ 0 & 0 & 0 & 1\end{matrix} ]$$

where α is the X-direction rotation value of 282, and RX is the translated X-direction rotation value of 382.

The Y coordinate value 283 is calculated with a Y matrix determinant to obtain a translated Y coordinate value 383. The Y matrix determinant is exemplary set as:

$$T Y = [ \begin{matrix}1 & 0 & 0 & 0 \\ 0 & 1 & 0 & b \\ 0 & 0 & 1 & 0 \\ 0 & 0 & 0 & 1\end{matrix} ]$$

where b is the Y coordinate value 283, and TY is the translated Y coordinate value 383.

The Y-direction rotation value 284 is calculated with a Y-direction rotation matrix determinant to obtain a translated Y-direction rotation value 384. The Y-direction rotation matrix determinant is exemplary set as:

$$R Y = [ \begin{matrix}cos ( β ) & 0 & sin ( β ) & 0 \\ 0 & 1 & 0 & 0 \\ - sin ( β ) & 0 & cos ( β ) & 0 \\ 0 & 0 & 0 & 1\end{matrix} ]$$

where β is the Y-direction rotation value of 284, and RY is the translated Y-direction rotation value of 384.

The Z coordinate value 285 is calculated with a Z matrix determinant to obtain a translated Z coordinate value 385. The Z matrix determinant is exemplary set as:

$$T Z = [ \begin{matrix}1 & 0 & 0 & 0 \\ 0 & 1 & 0 & 0 \\ 0 & 0 & 1 & c \\ 0 & 0 & 0 & 1\end{matrix} ]$$

where c is the Z coordinate value 285, and TZ is the translated Z coordinate value 385.

The Z-direction rotation value 286 is calculated by a Z-direction rotation matrix determinant to obtain a translated Z-directional rotation value 386. The Z-direction rotation matrix determinant is exemplary set as:

$$R Z = [ \begin{matrix}cos ( γ ) & - sin ( γ ) & 0 & 0 \\ sin ( γ ) & cos ( γ ) & 0 & 0 \\ 0 & 0 & 1 & 0 \\ 0 & 0 & 0 & 1\end{matrix} ]$$

where γ is the Z-direction rotation value of 286, and RZ is the translated Z-direction rotation value of 386.

The control access interface unit 21 receives the aforementioned signals generated by the operation of the joystick 28, and the calculation unit 11 executes the translation logic 12 for translation, and the robot access interface unit 31 transmits the translated X-coordinate value 381, the translated X-direction rotation value 382, the translated Y-coordinate value 383, the translated Y-direction rotation value 384, the translated Z-coordinate value 385, and the translated Z-direction rotation value 386 to the robot 38.

The aforementioned X matrix determinant, the X-direction rotation matrix determinant, the Y matrix determinant, the Y-direction rotation matrix determinant, the Z matrix determinant and the Z-direction rotation matrix determinant are merely examples since other options are available, including other known coordinate conversion formulas that can also be used for translation.

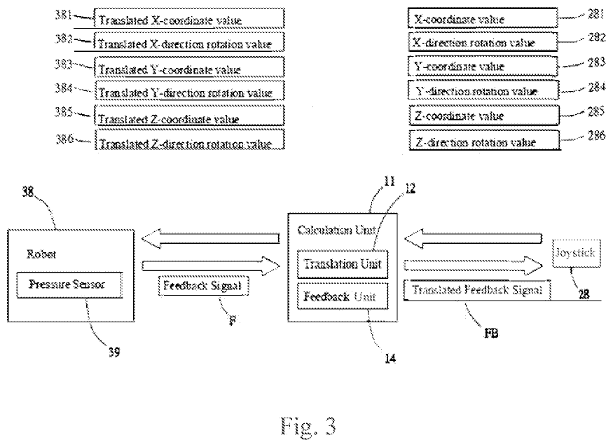

As shown in FIG. 3, the robot 38 in use can have a pressure sensor 39. The robot 38 is controlled in such a way that the pressure sensor 39 generates a feedback signal F by interacting with an object, which is received by the robot access interface unit 31 and transmitted to the calculation unit 11. A feedback logic unit 14 is used to calculate the feedback signal F generated by the robot 38 using a feedback algorithm to obtain a post-interpretation feedback value FB, which is transmitted to the joystick 28 by the control access interface unit 21. The feedback calculation formula in the exemplary embodiment is taken as an example in FB=K×F, whereby FB is the converted feedback value, K is the actual pressure value that is kept constant, and F is the value of the feedback signal F. The pressure sensor 39 can measure the pressure applied to the human body when the robot 38 touches an object, such as a human body, and the calculation unit 11 can use the feedback signal F to determine the force applied to the object, and control the robot 38 to stop or retract when the force is higher than a set value to avoid injury or damage to the object due to excessive force.

Another approach involves having the calculation unit 11 sending the feedback signal F directly to the joystick 28 via the control interface unit 21 without translating the feedback signal F. Whether this approach is used would depend on the needs of an operator.

The above describes the main structure of the present exemplary embodiment. The operational state of the present exemplary embodiment is discussed next.

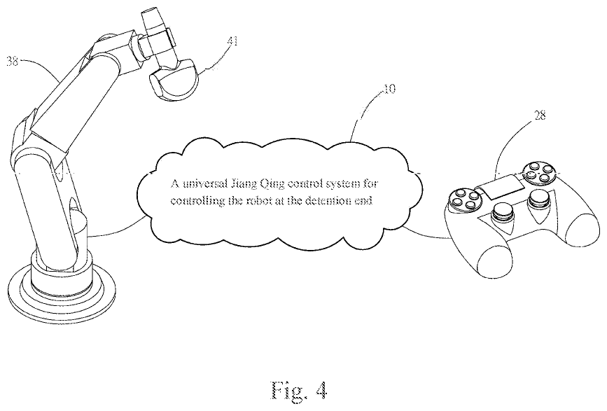

As shown in FIGS. 3 and 4, before operation, a joystick 28 and a robot 38 are connected to the universal translator control system 10 for remote control of the robot of the present invention, and the joystick 28 is a wireless joystick of a home TV game machine, and the robot 38 is a robot arm. In general, the remote control is usually performed with real-time video to allow the operator to observe the status of remote operation via the display device (not shown in the figure) on the video equipment.

During operation, the operator moves or rotates the joystick 28, and the joystick 28 senses its own motion and continuously generates six signals, namely X coordinate value 281, X-direction rotation value 282, Y coordinate value 283, Y-direction rotation value 284, Z coordinate value 285 and Z-direction rotation value 286, and continuously transmits them to the control access interface unit 21. The calculation unit 11 continuously receives these six signals and continuously translates these six signals into six translated values in X coordinate value 381, X-direction rotation value 382, Y rotation value 383, Y-direction rotation value 384, Z coordinate value 385 and Z-direction rotation value 386 by executing the translation logic 12. These six translated values are transmitted by the robot access interface unit 31 to the robot 38, which continuously moves or rotates according to the six translated values. In the operator's view, the motion of the robot 38 will be consistent with the motion generated by the operator's operation of the joystick 28, so that the operator can remotely control the ultrasonic scanning action of the robot 38.

If the robot 38 itself has the aforementioned pressure sensor 39, the feedback signal F measured by the pressure sensor 39 can also be fed back to the calculation unit 11, which can directly transmit the feedback signal F to the joystick 28, and the action of the joystick 28 in response to the feedback signal F can be vibration or light, so that the operator knows that the ultrasonic scanning device 41 held by the robot 38 has touched the human body. The operator knows that the ultrasonic scanning device 41 of the robot 38 has touched the human body. Further, when the feedback logic unit 14 is executed by the calculation unit 11, the feedback signal F can be further translated into a post-translation feedback value FB, for example, this post-translation feedback value FB can be regarded as the actual pressure value, and the post-translation feedback value FB is displayed as a value or line on the aforementioned video display device (not shown in the figure) for the operator to see. The operator can then understand the force value of the ultrasonic scanning device 41 held by the robot 38 on the human body.

As can be inferred from the above that if the joystick 28 is used with a smartphone, it can also produce similar effects by using the posture sensing function of the smartphone itself, and the joystick itself is not limited to the brand type, as long as it can generate the aforementioned six signals and can be connected, the technology of this invention can be applied.

One can see that the present disclosure allows for translation of the signals from different joysticks during operation into translated signals that can be received by the robot 38, and send the translated signals to the robot 38 for remote control thereof. In addition, the present disclosure can be applied to various joysticks, and has the effect of the operator choosing a familiar joystick as the universal joystick to operate, which overcomes the problem of higher learning threshold due to the proprietary interface in the conventional technology.

The present disclosure has been described with reference to the exemplary embodiments, and such description is not meant to be construed in a limiting sense. It should be understood that the scope of the present disclosure is not limited to the above-mentioned embodiment, but is limited by the accompanying claims. It is, therefore, contemplated that the appended claims will cover all modifications that fall within the true scope of the present disclosure. Without departing from the object and spirit of the present disclosure, various modifications to the embodiments are possible, but they remain within the scope of the present disclosure, will be apparent to persons skilled in the art.

What is claimed is:

1. A universal translator control system that can remotely control a robot with a joystick, comprising:
a control access interface unit electrically connected to the joystick in a wired or wireless manner, wherein the control access interface unit is used to interface an operational signal transmitted from the joystick, and wherein the operational signal generated by the joystick include at least an X coordinate value, an X-direction rotation value, a Y coordinate value, a Y-direction rotation value, a Z coordinate value, and a Z-direction rotation value;
a calculation unit electrically connected to the control access interface unit in a wired or wireless manner for receiving the operational signal interfaced by the control access interface unit, and for storing a translation logic and having an operation capability to execute the translation logic to perform translation, wherein the translation logic includes:
translating the X coordinate value by using an X matrix determinant to obtain a translated X coordinate value,
translating the X-direction rotation value by using an X-direction rotation matrix determinant to obtain a translated X-direction rotation value,
translating the Y coordinate value by using a Y matrix determinant to obtain a translated Y coordinate value,
translating the Y-direction rotation value by using a Y-direction rotation matrix determinant to obtain a translated Y-direction rotation value,
translating the Z coordinate value by a Z matrix determinant to obtain a translated Z coordinate value, and
translating the Z-direction rotation value by using a Z-direction rotation matrix determinant to obtain a translated Z-direction rotation value; and
a robot access interface unit electrically connected to the robot and the calculation unit in a wired or wireless manner, and transmits the translated X coordinate value, the translated X-direction rotation value, the translated Y coordinate value, the translated Y-direction rotation value, the translated Z coordinate value, and the translated Z-direction rotation value to the robot.

2. The universal translator control system according to claim 1, wherein the robot has a pressure sensor, and the pressure sensor is activated by a feedback signal which is generated by interacting with an object, and the feedback signal is received by the robot access interface unit and transmitted to the calculation unit.

3. The universal translator control system according to claim 2, wherein the calculation unit includes a feedback logic unit that calculates the feedback signal generated by the robot by a feedback algorithm to obtain an interpreted feedback value, which is transmitted to the joystick by the control access interface unit.

4. The universal translator control system according to claim 2, wherein the feedback signal is transmitted from the control access interface unit to the joystick.

5. The universal translator control system according to claim 1, wherein
The X matrix determinant is:
$$T X = [ \begin{matrix}1 & 0 & 0 & a \\ 0 & 1 & 0 & 0 \\ 0 & 0 & 1 & 0 \\ 0 & 0 & 0 & 1\end{matrix} ] ,$$
where a is the X coordinate value, and TX is the translated X coordinate value;
The determinant of the X-direction rotation matrix is:
$$R X = [ \begin{matrix}1 & 0 & 0 & 0 \\ 0 & cos ( α ) & - sin ( α ) & 0 \\ 0 & sin ( α ) & cos ( α ) & 0 \\ 0 & 0 & 0 & 1\end{matrix} ] ,$$
where α is the X-direction rotation value, and RX is the translated X-direction rotation value;
The Y matrix determinant is:
$$T Y = [ \begin{matrix}1 & 0 & 0 & 0 \\ 0 & 1 & 0 & b \\ 0 & 0 & 1 & 0 \\ 0 & 0 & 0 & 1\end{matrix} ] ,$$
wherein b is the Y coordinate value, and TY is the translated Y coordinate value;
The row and column of the Y-direction rotation matrix is:
$$R Y = [ \begin{matrix}cos ( β ) & 0 & sin ( β ) & 0 \\ 0 & 1 & 0 & 0 \\ - sin ( β ) & 0 & cos ( β ) & 0 \\ 0 & 0 & 0 & 1\end{matrix} ] ,$$
where β is the Y-direction rotation value, RY is the translated Y-direction rotation value;
The Z matrix determinant is:
$$T Z = [ \begin{matrix}1 & 0 & 0 & 0 \\ 0 & 1 & 0 & 0 \\ 0 & 0 & 1 & c \\ 0 & 0 & 0 & 1\end{matrix} ] ,$$
wherein c is the Z coordinate value, and TZ is the translated Z coordinate value;
The determinant of the Z-direction rotation matrix is:
$$R Z = [ \begin{matrix}cos ( γ ) & - sin ( γ ) & 0 & 0 \\ sin ( γ ) & cos ( γ ) & 0 & 0 \\ 0 & 0 & 1 & 0 \\ 0 & 0 & 0 & 1\end{matrix} ]$$
where γ is Z-direction rotation value, RZ is the translated Z-direction rotation value.
